(19) United States
(12) Patent Application Publication
(10) Pub. No.: US 2014/0283615 A1
(43) Pub. Date: Sep. 25, 2014

(54) DETERMINING A SEISMIC VIBRATOR SIGNATURE

(71) Applicant: WESTERNGECO L.L.C., HOUSTON, TX (US)

(72) Inventor: ROBERT MONTGOMERY LAWS, CAMBRIDGE (GB)

(73) Assignee: WESTERNGECO L.L.C., HOUSTON, TX (US)

(21) Appl. No.: 14/207,758

(22) Filed: Mar. 13, 2014

Related U.S. Application Data
(60) Provisional application No. 61/786,947, filed on Mar. 15, 2013.

(51) Int. Cl. G01V 1/04

(52) U.S. Cl. CPC G01V 1/04
USPC 73/662

(57) ABSTRACT

A method includes receiving a representation of a volume acceleration of a seismic vibrator. The method includes determining a signature of the seismic vibrator based at least in part on the representation of the volume acceleration.

### CROSS-REFERENCE TO RELATED APPLICATION

This application claims the benefit of U.S. Provisional Patent Application Ser. No. 61/786947 filed Mar. 15, 2013, which is incorporated herein by reference in its entirety.

### BACKGROUND

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensor, both hydrophones and geophones, and/or other suitable sensor types. A typical measurement acquired by a sensor contains desired signal content (a measured pressure or particle motion, for example) and an unwanted content (or “noise”).

### SUMMARY

The summary is provided to introduce a selection of concepts that are further described below in the detailed description. This summary is not intended to identify key or essential features of the claimed subject matter, nor is it intended to be used as an aid in limiting the scope of the claimed subject matter.

In an example implementation, a method includes receiving a representation of a volume acceleration of a seismic vibrator; and determining a signature of the seismic vibrator based at least in part on the representation of the volume acceleration.

In another example implementation, an apparatus includes at least one vibrating element and a sensor that is coupled to the vibrating element(s). The vibrating element(s) accelerates a volume of fluid to produce a seismic source event for a seismic vibrator, and the sensor acquires a measurement representing the acceleration.

In yet another example implementation, an article includes a non-transitory computer readable storage medium that stores instructions that when executed by a computer cause the computer to receive data that represents a volume acceleration of a seismic vibrator and determine a signature of the seismic vibrator based at least in part on the data.

Advantages and other features will become apparent from the following drawings, description and claims.

### BRIEF DESCRIPTION OF THE DRAWINGS

FIG. 1 is a schematic diagram of a towed seismic acquisition system according to an example implementation.

FIG. 2 is a flow diagram depicting a technique to determine the signature of a seismic vibrator according to an example implementation.

FIG. 3A is a schematic diagram of a seismic vibrator according to an example implementation.

FIGS. 3B and 3C are illustrations of vibrating elements of seismic vibrators according to example implementations.

FIG. 4 is a flow diagram depicting a technique to determine the signature of a seismic vibrator based at least in part on measurements of vibrating elements of the vibrator according to an example implementation.

FIGS. 5A and 5B are flow diagrams depicting techniques to determine the signature of a seismic vibrator having a vibrating element that includes a flexible surface according to an example implementation.

FIG. 6 is a flow diagram depicting a technique to determine the signature of a seismic vibrator using direct and indirect measurements of vibrating element movements according to an example implementation.

FIG. 7 is a flow diagram depicting a technique to determine the signatures of sources of a source array that contains a seismic vibrator and air guns according to an example implementation.

FIG. 8 is a schematic diagram of a data processing system according to an example implementation.

### DETAILED DESCRIPTION

Systems and techniques are disclosed herein for purposes of determining the notational source signature of a seismic vibrator based on one or more measurements of the volume acceleration of the vibrator. This approach differs, for example, from an approach that relies on near-field pressure measurements of a source (an approach that may be used to determine the notational source signature of an air gun, for example) to determine the source's signature because the measurement(s) of the volume acceleration may be acquired by sensors that are coupled to the vibrating element(s) of the seismic vibrator. The acquired measurement(s) are not affected by the operation of other sources (another seismic vibrator, an air gun, and so forth) that may be operated concurrently or otherwise emanating “interfering” energy. Thus, techniques and systems that are disclosed herein may be used to determine the notional source signature of a seismic vibrator, regardless of whether the vibrator is fired by itself or is simultaneously/near-simultaneously fired with one or more other seismic sources.

In accordance with example implementations that are disclosed herein, a given volume acceleration measuring sensor may be attached to or otherwise be coupled to a solid material of the vibrator, which vibrates by itself or in conjunction with one or more other materials of the vibrator to displace a volume of fluid for purposes of causing the vibrator to emanate seismic energy. For the examples that are disclosed herein, the measurement acquired by a given sensor may be an acceleration measurement, a measurement representing a velocity of the material or a measurement representing a displacement of the material. Regardless of the particular form of the measurement, the measurement may be processed along with possibly one or more other such measurements to determine the vibrator's volume acceleration; and the determined volume acceleration, in turn, may be used to derive the source signature. In this context, “coupling” of the sensor to the vibrating element material means that the sensor is constructed to acquire a direct measurement of the material's movement, such as through attachment or bonding; optical coupling; magnetic coupling; mechanical coupling; and so forth.

Although the seismic vibrator is described herein as being part of a towed marine seismic acquisition system, it is understood that the techniques and systems that are disclosed herein may likewise be applied to stationary marine seismic survey systems (seabed or ocean bottom cable (OBC)-based acquisition systems, for example) as well as land-based seismic acquisition systems. Moreover, the systems and techniques that are disclosed herein may be applied to non-seismic imaging acquisition and processing systems. Thus, many implementations are contemplated, which are within the scope of the appended claims.

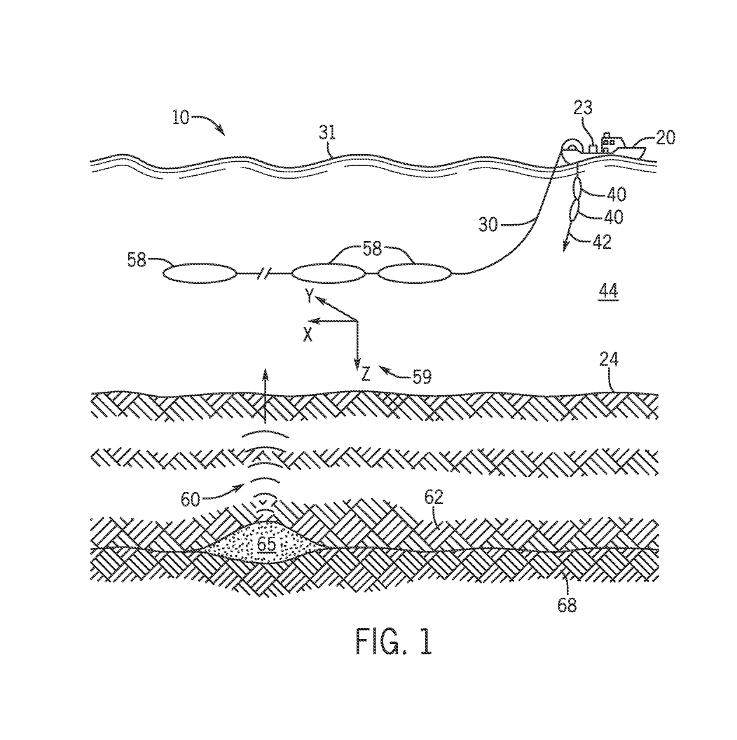

Referring to FIG. 1, as an example of a towed survey, marine-based seismic data acquisition system 10, a survey vessel 20 of the system 10 tows one or more seismic streamers 30 (one exemplary streamer 30 being depicted in FIG. 1). It is noted that the streamers 30 may be arranged in an array, or spread, in which multiple streamers 30 are towed in approximately the same plane at the same depth. As another non-limiting example, the streamers 30 may be towed at multiple depths, such as in an over/under spread, for example. Moreover, the streamers 30 of the spread may be towed in a coil acquisition configuration and/or at varying depths or slants, depending on the particular implementation.

A given streamer 30 may be several thousand meters long and may contain various support cables (not shown), as well as wiring and/or circuitry (not shown) that may be used to support communication along the streamer 30. In general, the streamer 30 includes a primary cable into which is mounted seismic sensors that record seismic signals. In accordance with example implementations, the streamer 30 contains seismic sensor units 58, each of which contains a multi-component sensor. The multi-component sensor includes a hydrophone and particle motion sensors, in accordance with some implementations. Thus, each sensor unit 58 is capable of detecting a pressure wavefield and at least one component of a particle motion that is associated with acoustic signals that are proximate to the sensor. Examples of particle motions include one or more components of a particle displacement, one or more components (inline (x), crossline (y) and vertical (z) components (see axes 59, for example)) of a particle velocity and one or more components of a particle acceleration.

Depending on the particular implementation, the multi-component sensor may include one or more hydrophones, geophones, particle displacement sensors, particle velocity sensors, accelerometers, pressure gradient sensors, or combinations thereof

As a more specific example, in accordance with some implementations, a particular multi-component sensor may include a hydrophone for measuring pressure and three orthogonally-aligned accelerometers to measure three corresponding orthogonal components of particle velocity and/or acceleration near the sensor. It is noted that the multi-component sensor may be implemented as a single device (as depicted in FIG. 1) or may be implemented as a plurality of devices, depending on the particular embodiment of the invention. A particular multi-component sensor may also include pressure gradient sensors, which constitute another type of particle motion sensors. Each pressure gradient sensor measures the change in the pressure wavefield at a particular point with respect to a particular direction.

In addition to the streamers 30 and the survey vessel 20, the acquisition system 10 includes a source spread, or array, which includes at least one seismic source 40, such as the two exemplary seismic sources 40 that are depicted in FIG. 1. More specifically, in accordance with example implementations, the seismic sources 40 contain at least one seismic vibrator that is constructed to displace a volume of fluid in a manner that emanates energy to produce a seismic event due to the operation of one or more vibrating elements of the vibrator. Depending on the particular implementation, the sources 40 may also contain one or more air guns. Techniques and systems are disclosed herein for determining notional source signature(s) for all of the seismic source(s) 40, regardless of whether the source(s) 40 are vibrator(s) or a combination of vibrator(s) and air gun(s). The rotational source signature(s) may be used to process the acquired seismic measurements, as can be appreciated by the skilled artisan.

In accordance with some example implementations, the seismic sources 40 may be coupled to, or towed by, a vessel that tows seismic sensors, such as the survey vessel 20. Alternatively, in other implementations, the seismic sources 40 may operate independently of the survey vessel 20, in that the sources 40 may be coupled to other vessels or buoys, as just a few examples. In yet further implementations, multiple vessels may tow the seismic sources 40.

As the seismic streamers 30 are towed, the energies produced by the seismic sources 40 generate acoustic waves 42, which are directed down through a water column 44 into strata 62 and 68 beneath a water bottom surface 24. The acoustic waves 42 are reflected from the various subterranean geological formations, such as an exemplary formation 65 that is depicted in FIG. 1.

The incident acoustic waves 42 produce corresponding reflected acoustic waves 60, which are sensed by the seismic sensors of the streamer(s) 30. It is noted that the acoustic waves that are received and sensed by the seismic sensors include “up going” pressure waves that propagate to the sensors without reflection, as well as “down going” pressure waves that are produced by reflections of the pressure waves 60 from an air-water boundary, or free surface 31.

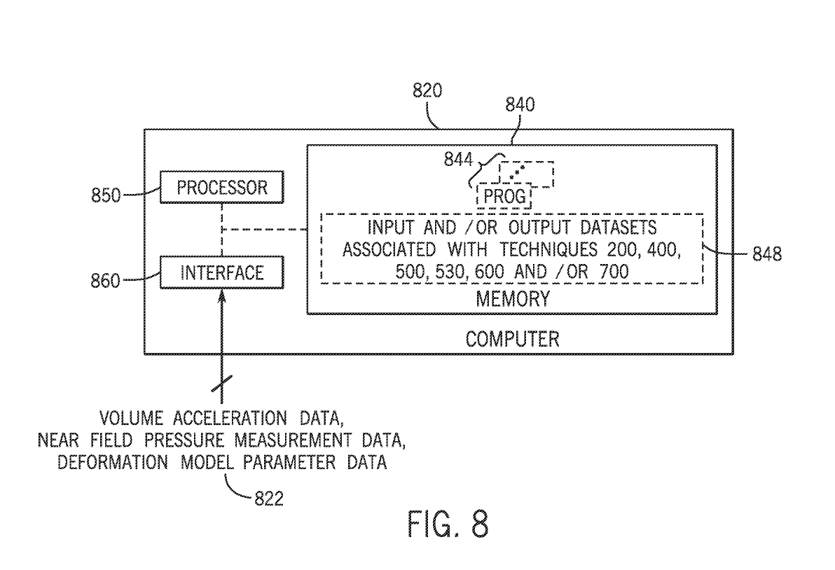

The seismic sensors of the streamers 30 generate signals (digital signals, for example), called “traces,” which form the acquired measurements of the pressure wavefield and particle motion. The traces are recorded as seismic data and may be at least partially processed by a signal processing unit 23 that is deployed on the survey vessel 20, in accordance with some implementations and/or may be further processed, in general, by a local or remote data processing system, such as the data processing system that is generally depicted in FIG. 8 and described below. As an example, a particular multi-component sensor may provide a trace, which corresponds to a measure of a pressure wavefield by its hydrophone; and the sensor may provide (depending on the particular implementation) one or more traces that correspond to one or more components of particle motion.

A given seismic source 40, under the appropriate conditions, may be modeled as a monopole. In this manner, the far field pressure signal that is produced by a source 40, which is relatively small as compared to the wavelength of the signal, depends on the volume of the source 40 and not on the particular shape of the source. Such as source may be referred to as a small pulsating source and may be considered to radiate as a monopole. A pressure field (called “p(t,r)” at range (called “r”) and time (called “t”) in an infinite homogeneous volume of water from such a small pulsating source has a notional source signature (called “S(t)”) that may be described as follows:

$$p ( t , r ) = S ( t - \frac{r}{c} ) / r . \qquad Eq . 1$$

Given the relationship described above in Eq. 1, the notational source signature of a single air gun may be determined by measuring the near pressure wavefield of the air gun. A given source array may, however, contain multiple air guns, which are arranged in an array of monopoles (one gun for each bubble, or cluster). For purposes of determining the source signature for each of these air guns, multiple near field pressure measurements may be acquired; and the corresponding source signatures may be determined from these measurements. As further described herein, because each near field pressure measurement is a result of bubbles, or clusters, produced by all of the air guns, the technique used to determine the source signature for a given air gun takes all of these contributions into account.

For a small pulsating source, the notional source signature S(t) is proportional to the second time differential, or acceleration, of the source's volume (called “V(t)”), as described below:

$$S ( t ) = \frac{ρ}{4 π} \frac{{d}^{2} V ( t )}{d {t}^{2}} , \qquad Eq . 2$$

where “ρ” represents the density of water.

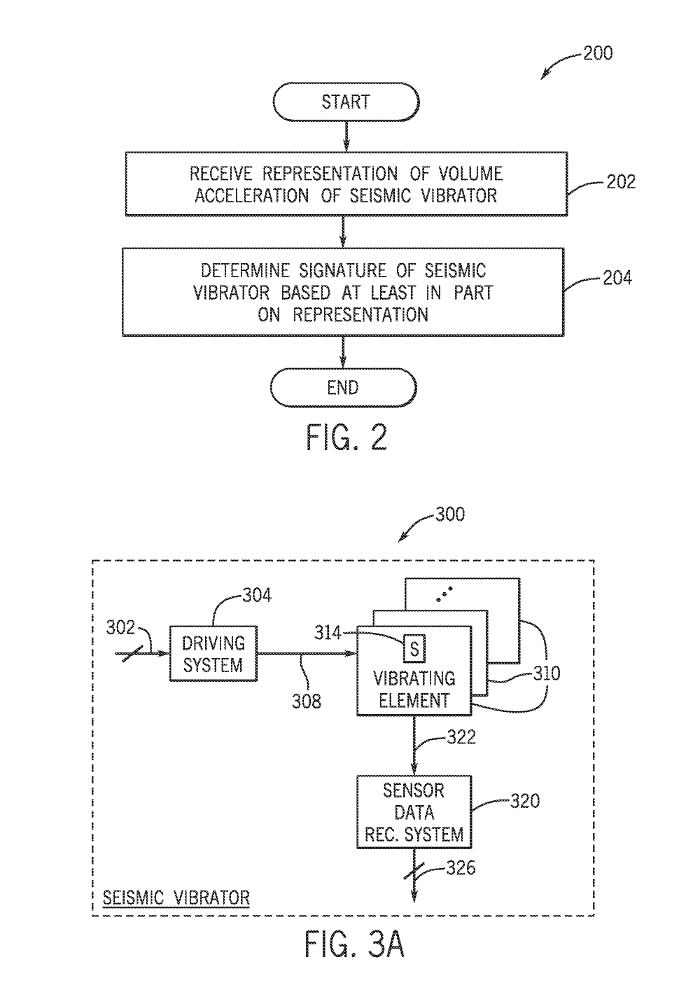

Systems and techniques are disclosed herein, which use the relationship between the source signature and the volume acceleration, as expressed in FIG. 2, for purposes of determining the notational source signature of a seismic vibrator. More specifically, according to a technique 200 that is depicted in FIG. 2, a representation of the volume acceleration of a seismic vibrator is received (block 202); and, pursuant to the technique 200, the signature of seismic vibrator is determined (block 204) based at least in part on this representation.

It is noted that the source signature S(t) of a particular seismic vibrator depends on the volume V(t) of that vibrator. The S(t) of a particular vibrator can be determined from that vibrator's V(t) without the need for any knowledge of the behavior of any other vibrators or sources that may be operating nearby. If there is interference between the sources such that S(t) is modified from the form it would have if the vibrator were operating alone then that interference is found correspondingly in V(t). Because the seismic vibrator has at least one vibrating element, i.e., a solid material, which is in continuous contact with the water, one or multiple sensors may be coupled to the material(s) to acquire measurements representative of the movement(s) of the material(s), and the movement may be used to derive the volume acceleration and source signature S(t).

As an example, in accordance with some implementations, the sensors may be accelerometers. In further implementations, the sensors may be displacement sensors that are constructed to measure displacements or particle velocity sensors that are constructed to measure velocities.

In accordance with some implementations, the sensors may be analog sensors that acquire continuous measurements; and in accordance with further implementations, the sensors may be sensors that acquire discrete, sampled measurements at sampling time intervals. It is noted that for these implementations, the time sample rate satisfies the Nyquist criteria in that after the application of an anti-aliasing filter, the sample frequency is at least twice the highest frequency of interest.

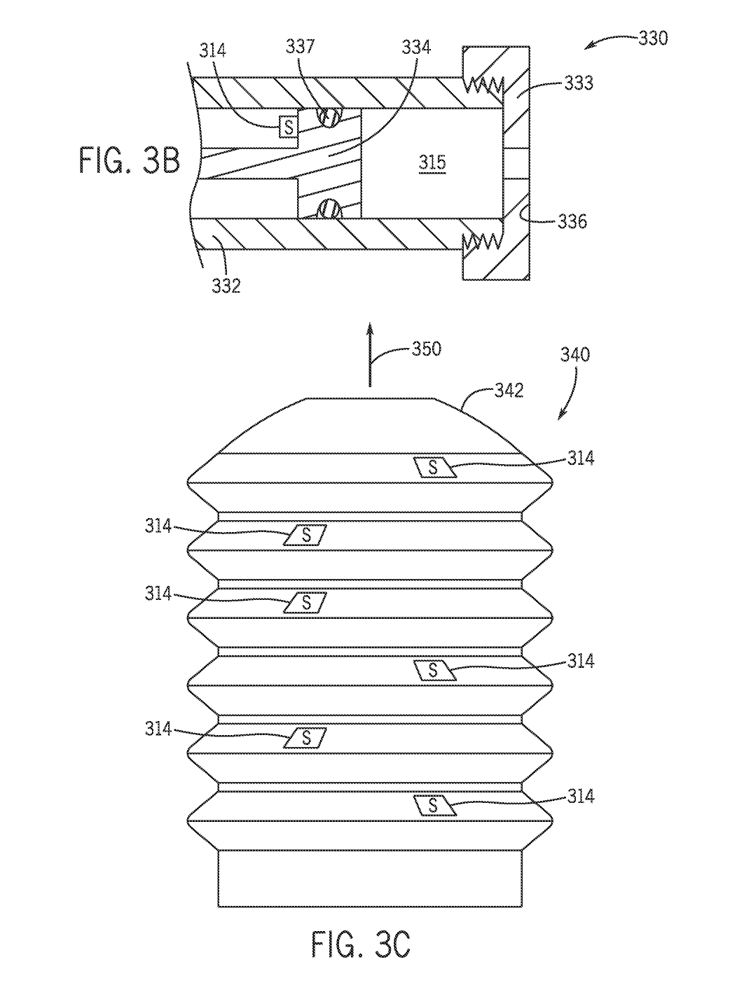

Referring to FIG. 3A, in accordance with some implementations, a given seismic vibrator 300 may, in general, contain a driving system 304, which receives a control signal (via input terminals 302) for purposes of actuating one or more vibrating elements 310 of the vibrator 300. In this manner, the driving system 304 may, for example, operate an actuating element 308 for purposes of driving the vibrating elements 310. The seismic vibrator 300 may take on numerous forms, depending on the particular implementation. For example, in accordance with some implementations, the seismic vibrator 300 may employ piezoelectric-based vibrating elements 310; and as such, the actuating element 308 may be one or more communication lines communicating the appropriate voltage(s) to the vibrating elements 310. As another example, the seismic vibrator 300 may be a mechanical-based device that drives a spring-based actuating element 308 for purposes of causing the vibrating elements 310, which are coupled thereto, to vibrate. The actuating element 308 may be a reciprocating linkage, in accordance with further example implementations.

Regardless of the particular design of the seismic vibrator 300, the motion of at least one of the vibrating elements 310 is monitored by an associated sensor 314, which acquires data representing the movement of the element 310 (data representing the acceleration, displacement and/or velocity of the element 310, for example). Depending on the particular implementation, the sensor 314 may be attached (bonded to, mounted to, and so forth) to the associated vibrating element 310 or may be otherwise coupled (optically coupled, magnetically coupled, and so forth) for purposes of directly acquiring at least one measurement that is representative, or indicative of, the motion of the associated vibrating element 310. From the measurement(s) of the movement(s) of the vibrating elements 310, the volume acceleration may then be determined based on the relationship between the measurement movement(s) and the corresponding volume acceleration.

As depicted in FIG. 3A, the seismic vibrator 300, in accordance with example implementations, includes a sensor data recording system 320, which has corresponding inputs 322 for purposes of receiving the data acquired by the sensor(s) 314. The input(s) 322 may be electrical, electromagnetic, magnetic and/or optical signals or any other type of signals, depending on the particular implementation. As further depicted in FIG. 3A, the sensor data recording system 320 has one or multiple outputs 326 for purposes of providing the acquired sensor data to an external system (the data processing system of FIG. 8, for example) for purposes of further processing the acquired measurements, as discussed herein.

FIG. 3B depicts an example illustrative portion 330 of a seismic vibrator in accordance with example implementations. For this example, the seismic vibrator includes a reciprocating system, or plunger 334 which is disposed inside a cylinder 332 which is sealably disposed (via an o-ring 337, for example) inside the cylinder 332 for purposes of controllably changing a volume 315 of fluid inside the chamber 332 to produce a corresponding seismic event. As illustrated in FIG. 3B, for this example, cap 333 encloses one end of the cylinder 332 and contains an opening 336 for purposes of allowing the fluid from the volume 315 to escape. A sensor 314 is attached to the piston 334 for purposes of measuring movement of the piston 334. Thus, by acquiring measurements of the movement of the piston 334, a corresponding acceleration of the volume 315 may be determined for the seismic vibrator.

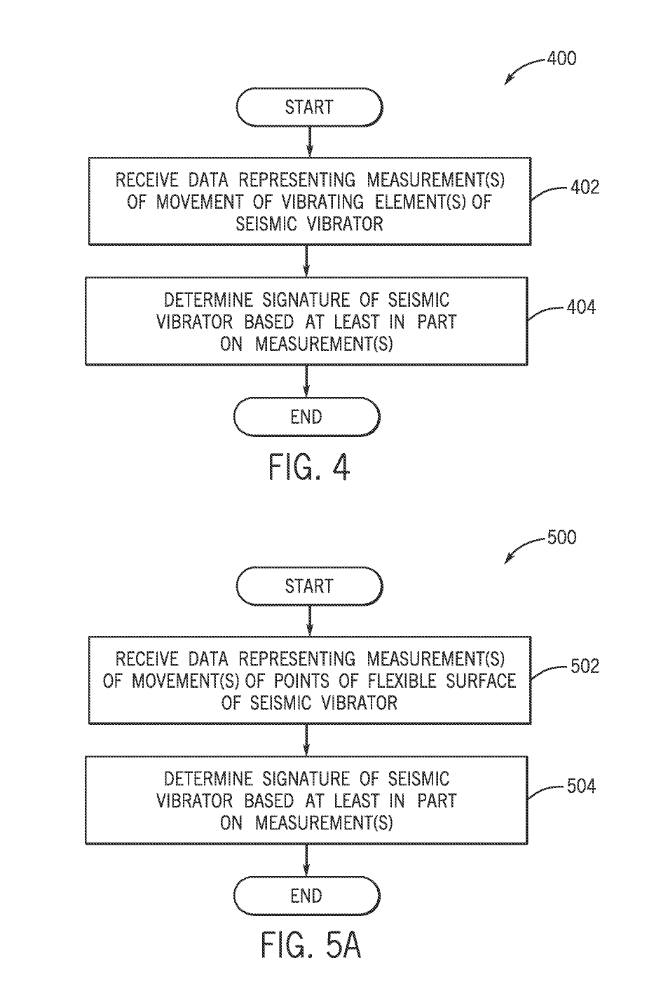

Thus, referring to FIG. 4, a technique 400 in accordance with example implementations includes receiving (block 402) data, which represents one or more measurements of movements of vibrating elements of a seismic vibrator. Pursuant to the technique 400, the signature of the seismic vibrator is determined (block 404) based at least in part on the measurement(s).

Other seismic vibrators may contain flexible surfaces or materials that serve as the vibrating elements. For example, FIG. 3C depicts a selected portion 340 of a seismic vibrator having a bellows 342 that moves along a direction 350 for purposes of selectively compressing and expanding a volume of fluid inside the bellows 342. For this example, sensors 314 are attached to different points of the bellows 342 for purposes of measuring the volume acceleration. The measurements of the bellows' movement are acquired by the sensors 314, which are distributed with a sufficient spatial density to satisfy the corresponding Nyquist sampling criteria to adequately sample the change in volume, in accordance with example implementations.

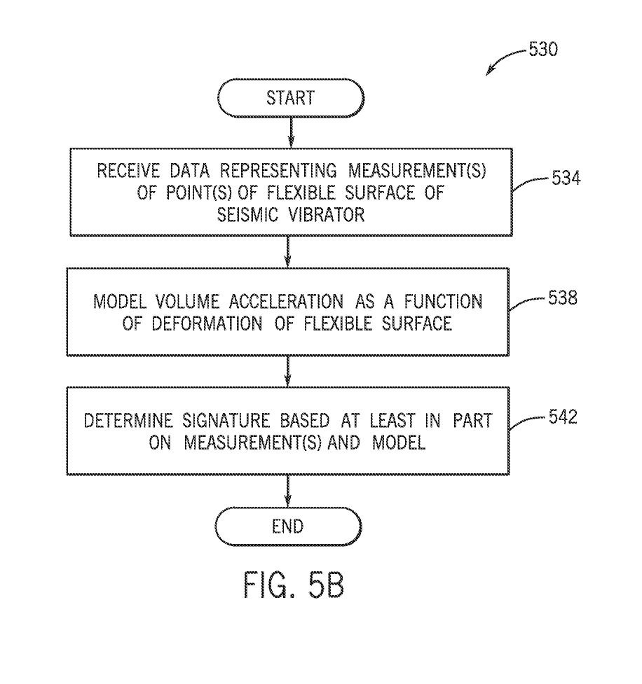

Thus, referring to FIG. 5A, in general, in accordance with example implementations, a technique 500 includes receiving (block 502) data, which represents measurements at points of a flexible surface of a seismic vibrator. The technique 500 includes determining (block 504) the signature of the seismic vibrator based at least in part on the measurements.

In accordance with further example implementations, a set of fewer measurements that do not necessarily satisfy the Nyquist criteria may be used in combination with a model that describes the change in volume due to the movement of a flexible surface. For example, referring to FIG. 3B, as few as one sensor 314 may be attached to the bellows 314 for purposes of measuring movement of the bellows in the direction 350. By measuring the position of the sampled point, a mathematical model may be applied that relates the axial position of the sensor to the corresponding volume change. Therefore, using the measurement acquired by the sensor 314 and the model, a corresponding volume acceleration may be determined.

Thus, in accordance with example implementations, a technique 530 (see FIG. 5B) includes receiving (block 534) data representing one or more measurements at point(s) of a flexible surface of a seismic vibrator and modeling (block 538) a deformation of the flexible surface. The signature of the seismic vibrator may then be determined (pursuant to block 542), based at least in part on the measurement(s) and the model.

In general, some designs of vibrator may be be modeled sufficiently well that relatively few sensor measurements (even one sensor measurement, for example) are sufficient to characterize the motion of all moving surface(s) of the vibrator. As an example, the movement of one surface of the vibrator (which affects the volume) may be estimated based on the measured movement of another surface of the vibrator (which also affects the volume). For example, a given vibrator may have two moving surfaces of identical shape and mass, with one surface moving in the opposite direction to the other. Movements of these surfaces may be measured by using one sensor placed on one surface and by applying the assumption that the other surface moves in exactly the same way but in the reverse direction.

It is noted that in accordance with some implementations, redundant measurements may be omitted. This may be case if the volume does not change when a particular surface element is moved on its own. For example, a given vibrator may include a cylinder with two identical movable pistons at its ends to change the vibrator's volume. Sensors may be disposed on the piston portions and not on the cylindrical part, as movement of the cylindrical part does not affect the volume.

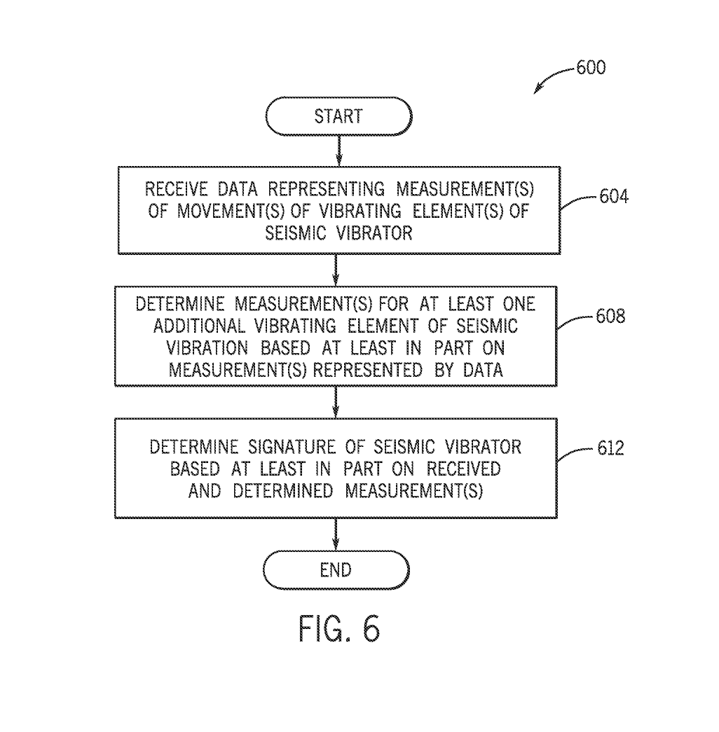

Thus, pursuant to a technique 600 of FIG. 6, data representing measurement(s) of the movement(s) of vibrating elements of a seismic vibrator are received, pursuant to block 604; and one or more measurements for at least one additional vibrating element of the seismic vibrator are determined (block 608) based at least in part on the measurements that are represented by the data. The technique 600 includes determining (block 612) the signature of the seismic vibrator based at least in part on the received and determined measurement(s).

In accordance with some implementations, a given source array may contain one or more seismic vibrators and one or more air guns. For purposes of determining the source signatures of the air gun(s) and seismic vibrator(s) of such a source array, the following technique may be employed, in accordance with some implementations. First, the source signature(s) of the seismic vibrator(s) are determined, as discussed above. It is noted that the signatures for the seismic vibrators may be determined independently of any other sources of the composite seismic source. The source signatures for the air guns are determined in a manner in which near field pressure measurements (acquired by near field hydrophones on the streamer 30, for example) are employed. These near field pressure measurements are influenced by all of the sources of the composite seismic source, such as all of the air gun(s) and all of the seismic vibrator(s). As such, the following technique may be used for purposes of determining the source signature for each air gun.

For each air gun, a corresponding source signature (called “Sⱼ(t)” where the index “j” designates a particular air gun) may be determined using the following relationship:

$${S}_{j} ( t ) = {r}_{jj} {N}_{j} ( t - \frac{{r}_{jj}}{c} ) - {\sum }_{i \neq j}^{ } \frac{{S}_{i} ( t - ( {r}_{ij} - {r}_{jj} ) / c )}{{r}_{ij}} - γ {\sum }_{i}^{ } \frac{{S}_{i} ( t - ( {h}_{ij} - {r}_{jj} ) / c )}{{h}_{ij}} . \qquad Eq . 3$$

In Eq. 3, “r” represents the distance from the jth hydrophone to the jth bubble; and “Nⱼ” represents the jth pressure measurement. Moreover, “c” represents the velocity of sound; and “Sᵢ” represents the source signature(s) of the one or more other air gun(s). The “rᵢⱼ” distance is the distance between the ith hydrophone and the jth bubble; and “rᵢₖ” represents the distance from the ith hydrophone to the kth seismic vibrator. Also, in Eq. 3, “γ” represents the sea surface reflection coefficient (−1, for example); “hᵢⱼ” represents the reflected path corresponding to the direct path rᵢⱼ; and “hᵢₖ” represents the reflected path corresponding to the direct path rᵢₖ.

With Eq. 3 being defined for each air gun, the set of equations may be inverted in, for example, an iterative process for purposes of determining the air gun notational source signatures.

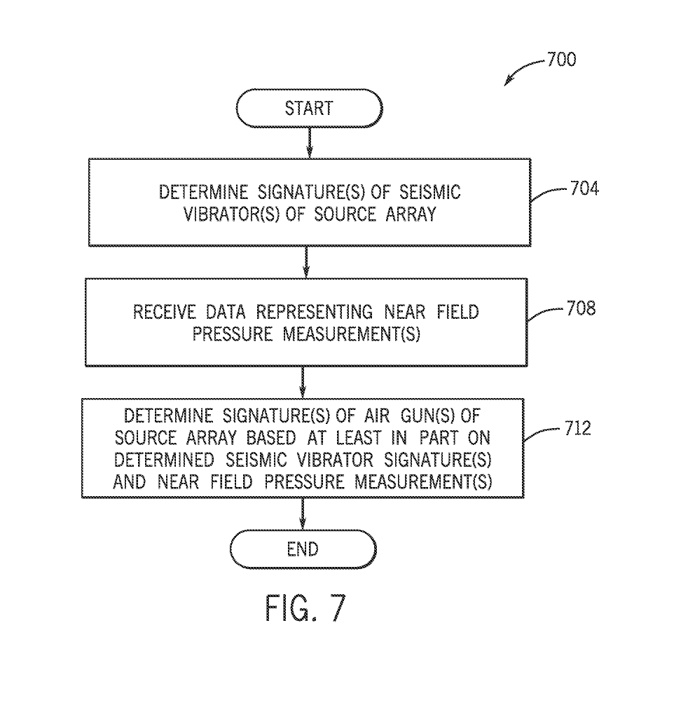

Thus, referring to FIG. 7, in accordance with example implementations, a technique 700 includes determining (block 704) one or more signatures of one or more corresponding seismic vibrators of a source array containing vibrator and air gun sources and receiving (block 708) data, which is representative of near field pressure measurements of the source array. The technique 700 includes determining (block 712) the signature(s) of the air gun(s) of the source array based at least in part on the determined seismic vibrator signature(s) and the near field pressure measurements.

Referring to FIG. 8, in accordance with some implementations, a machine, such as a data processing system 820, may contain a processor 850 for purposes of determining the notational source signature(s) for the sources of a source array that contains at least one vibrator and may include one or more air guns.

In accordance with some implementations, the processor 850 may be formed from one or more microprocessors and/or microprocessor processing cores. In general, the processor 850 is a general purpose processor, and may be formed from, depending on the particular implementation, one or multiple central processing units (CPUs), or application specific integrated circuits (ASICs), field programmable gate arrays (FPGAs), programmable logic devices (PLDs), or other appropriate devices, as can be appreciated by the skilled artisan. As a non-limiting example, the processor 850 may be part of the circuitry 23 (see FIG. 1) on the vessel 20, or may be disposed at a remote site. Moreover, the data processing system 820 may be a distributed processing system, in accordance with further implementations.

As depicted in FIG. 8, the processor 850 may be coupled to a communication interface 860 for purposes of receiving data 822, which may (as examples) represent volume acceleration data (e.g., accelerometer data, data indicative of velocity(ies) or displacement(s), and so forth); near field pressure measurement data; deformation model parameter data; data representing surface vibrator(s); and so forth. As examples, the communication interface 860 may be a Universal Serial Bus (USB) interface, a network interface, a removable media interface (a flash card, CD-ROM interface, etc.) or a magnetic storage interface (an Intelligent Device Electronics (IDE)-compliant interface or Small Computer System Interface (SCSI)-compliant interface, as non-limiting examples). Thus, the communication interface 860 may take on numerous forms, depending on the particular implementation.

In accordance with some implementations, the processor 850 is coupled to a memory 840 that stores program instructions 844, which when executed by the processor 850, may cause the processor 850 to perform various tasks of one or more of the techniques that are disclosed herein, such as the techniques 200, 400, 500, 530, 600 and/or 700, as examples.

As a non-limiting example, in accordance with some implementations, the instructions 844, when executed by the processor 850, may cause the processor 850 to receive a representation of a volume acceleration of a seismic vibrator and determine a signature of the seismic vibrator based at least in part on this representation. Moreover, the instructions 844 may cause the processor 850 to perform a variety of additional techniques, relating to movement interpolation, surface deformation modeling, related element movement modeling, air gun signature determination, and so forth, as disclosed herein.

In general, the memory 840 is a non-transitory storage medium and may take on numerous forms, such as (as non-limiting examples) semiconductor storage, magnetic storage, optical storage, phase change memory storage, capacitor-based storage, and so forth, depending on the particular implementation. Moreover, the memory 840 may be formed from more than one of these non-transitory storage mediums, in accordance with further implementations. When executing one or more of the program instructions 844, the processor 850 may store preliminary, intermediate and/or final results obtained via the execution of the instructions 844 as data 848 that may be stored in the memory 840.

It is noted that the data processing system 820 is merely an example of one out of many possible architectures, in accordance with the techniques and systems that are disclosed herein. Moreover, the data processing system 820 is represented in a simplified form, as the processing system 820 may have various other components (a display to display initial, intermediate and/or final results of the system's processing, as non-limiting examples), as can be appreciated by the skilled artisan.

Other variations are contemplated, which are within the scope of the appended claims. For example, the systems and techniques that are disclosed herein may be applied to energy measurement acquisitions systems, other than seismic acquisition systems. For example, the techniques and systems that are disclosed herein may be applied to non-seismic-based geophysical survey systems, as electromagnetic or magnetotelluric-based acquisition systems, in accordance with further implementations. The techniques and systems that are disclosed herein may also be applied to energy measurement acquisition systems, other than systems that are used to explore geologic regions. Thus, although the surveyed target structure of interest described herein is a geologic structure, the target structure may be a non-geologic structure (human tissue, a surface structure, and so forth), in accordance with further implementations.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
receiving a representation of a volume acceleration of a seismic vibrator; and
determining a signature of the seismic vibrator based at least in part on the representation of the volume acceleration.

2. The method of claim 1, wherein receiving the representation of the volume acceleration comprises receiving data representing a measurement acquired by a sensor coupled to a vibrating element of the seismic vibrator.

3. The method of claim 1, wherein receiving the representation of the volume acceleration comprises receiving data representing a measurement acquired by an accelerometer.

4. The method of claim 1, further comprising:
receiving an indirect representation of the volume acceleration of the seismic vibrator; and
converting the indirect representation into the representation of the volume acceleration.

5. The method of claim 4, wherein receiving the indirect representation of the volume acceleration comprises receiving data indicative of a displacement or a velocity of a vibrating element of the seismic vibrator.

6. The method of claim 1, wherein receiving the representation of the volume acceleration comprises receiving data acquired by a plurality of sensors coupled to vibrating elements of the seismic vibrator.

7. The method of claim 1, wherein receiving the representation of the volume acceleration comprises receiving data representing measurements acquired by a plurality of sensors coupled to a flexible surface of the seismic vibrator, the method further comprising determining the volume acceleration based at least in part on the data.

8. The method of claim 1, further comprises determining the volume acceleration based at least in part on a model representing a deformation of a flexible surface of the seismic vibrator.

9. The method of claim 1, wherein receiving the representation of the volume acceleration comprises receiving data representing a measurement acquired by a sensor coupled to a first location of a surface of the seismic vibrator, the method further comprising determining the volume acceleration based at least in part on an inference about another location of the flexible surface based on the measurement acquired by the sensor.

10. The method of claim 1, wherein the seismic vibrator is part of a source array comprising the seismic vibrator and the plurality of air guns, the method further comprising:
receiving a plurality of pressure measurements acquired in response to operation of the source; and
for each air gun of the plurality of air guns, determining a signature of the air gun based at least in part on the determined signature of the seismic vibrator and the pressure measurements.

11. An apparatus comprising:
at least one vibrating element to accelerate a volume of fluid to produce a seismic source event for a seismic vibrator; and
a sensor coupled to the at least one vibrating element to acquire a measurement representing the acceleration.

12. The apparatus of claim 11, wherein the sensor comprises a sensor selected from the group consisting essentially of an accelerometer, a sensor adapted to measure velocity; and a sensor adapted to measure a displacement.

13. The apparatus of claim 11, wherein the apparatus further comprises:
at least one additional vibrating element; and
at least one additional sensor coupled to the at least one additional vibrating element to acquire a measurement representative of the acceleration.

14. An apparatus comprising:
an interface to receive data representative of a volume acceleration of a seismic vibrator; and
a processor to process the data to determine a signature of the seismic vibrator.

15. The apparatus of claim 14, wherein the processor is adapted to determine the signature based at least in part on an acceleration, displacement or velocity represented by the data.

16. The apparatus of claim 14, wherein the data represents a measurement acquired by a sensor attached to a vibrating element of the seismic vibrator.

17. The apparatus of claim 14, wherein the processor is adapted to determine the signature based at least in part on the data and a model of a deformation for a flexible surface of the seismic vibrator.

18. An article comprising a non-transitory computer readable storage medium storing instructions that when executed by a computer cause the computer to:
receive data representing a volume acceleration of a seismic vibrator; and
determine a signature of the seismic vibrator based at least in part on the data.

19. The article of claim 18, wherein the seismic vibrator is part of a source array comprising the seismic vibrator and a plurality of air guns, the storage medium storing instructions that when executed by the computer cause the computer to receive data representing a plurality of pressure measurements acquired in response to operation of the air guns and for each of the air guns, determine a signature of the air gun based at least in part on the determined signature of the seismic vibrator and the pressure measurements.

20. The article of claim 18, the storage medium storing instructions that when executed by the computer cause the computer to determine the signature based at least in part on a model describing a volume of the seismic vibrator as a function of a motion of a flexible element of the seismic vibrator.
